(19) United States
(12) Patent Application Publication
(10) Pub. No.: US 2012/0106135 A1
(43) Pub. Date: May 3, 2012

(54) CEILING MOUNT LAMP HAVING A FIXING STRUCTURE CAPABLE OF ASSISTING HEAT DISSIPATION

(76) Inventor: Tsu-Wang Chen, New Taipei City (TW)

(21) Appl. No.: 13/168,691

(22) Filed: Jun. 24, 2011

(30) Foreign Application Priority Data
Nov. 2, 2010 (TW) 099221208

(51) Int. Cl. F21S 8/04

(52) U.S. Cl. 362/147

(57) ABSTRACT

A ceiling mount lamp having a fixing structure capable of assisting heat dissipation is disclosed. The ceiling mount lamp includes a fixing unit including a frame body and a back plate, and a lighting unit installed between the frame body and the back plate. At least one side of the light guide plate is provided with a circuit board on which an LED unit is disposed, and at least one side between the frame body and the back plate of the fixing unit is mounted with a U-shaped fixing member. One outer surface of the U-shaped fixing member is fastened with the circuit board, and another outer surface of the U-shaped fixing member is provided with at least a hook part, which provides an elastic force to push against the circuit board and the LED unit, such that the LED unit is pressed close to the light guide plate.

### BACKGROUND OF THE INVENTION

1. Field of the Invention

The present invention relates to a ceiling mount lamp having a fixing structure, especially a U-shaped fixing structure having functions of heat conduction and dissipation, and buckling.

2. The Prior Arts

Currently, luminaries mounted on ceilings are often used in home or offices. Such luminaries typically include chandeliers and ceiling mount fluorescent lamps. Generally, a typical chandelier often occupies a large space. When such a chandelier is provided in a house with a 2.7 m floor height, the space may be looked crowd and discordant. As to office used lamps, in most circumstances, ceiling mount fluorescent lamps are selected. A typical ceiling mount fluorescent lamp adapted for office use is a fluorescent lamp tube secured in a frame. Specifically, the frame is a flat metal-made π-shaped structure. The fluorescent lamp tube is secured inside the space defined in the frame, and a rectifier is secured on a backside of the frame or inside the space of the frame. Both of the foregoing luminaries disadvantageously consume much energy, and do not satisfy the demand of environmental protection.

At present, the energy-saving feature of LED lamps is very welcome in the marketplace. So, developing an LED ceiling mount lamp is a solution to satisfy the requirements of energy saving and environmental protection. However, a conventional LED ceiling mount lamp often has shortages of poor heat dissipation which may reduce the service life of the LED, and the LED and a light guide plate of the ceiling mount lamp is not sufficiently pressed close to each other. A gap between the LED and the light guide plate would result in that the light guide performance of the light guide plate and the illumination are not able to be efficiently enhanced.

### SUMMARY OF THE INVENTION

A primary objective of the present invention is to provide a ceiling mount lamp having a fixing structure capable of assisting heat dissipation, which has a structure simple, easy to be assembled and disassembled, and enable to increase the compactness arrangement of parts.

For achieving the above-mentioned objectives, a ceiling mount lamp having a fixing structure capable of assisting heat dissipation according to the present invention comprises a fixing unit and a lighting unit.

The fixing unit comprises a frame body having folded edges equipped with at least one hook hole, and a back plate assembled with the frame body and having buckling edges equipped with at least one buckling hole.

The lighting unit is installed between the frame body and the back plate of the fixing unit. The lighting unit comprises a reflective sheet, a light guide plate, and a diffusion sheet. The reflective sheet is installed on the back plate of the fixing unit, and the light guide plate installed on the reflective sheet. At least one side of the light guide plate is provided with a circuit board on which an LED unit is disposed. Light emitted by the LED unit is reflected by the reflective sheet, and the light guide plate is provided for guiding the light emitted by the LED unit and reflected from the reflective sheet. The diffusion sheet is installed on the light guide plate and provided for further diffusing and softening the light emitted by the LED unit and reflected from the reflective sheet.

At least one side between the frame body and the back plate of the fixing unit is mounted with a U-shaped fixing member. One outer surface of the U-shaped fixing member is fastened with the circuit board, and another outer surface of the U-shaped fixing member is provided with at least a hook part, which provides an elastic force to push against the circuit board and the LED unit, such that the LED unit is pressed close to the light guide plate, thereby the light guide performance of the light guide plate and the illumination can be enhanced.

By means of the above technical solutions of the present invention, when the LED unit is lit, the heat generated by the LED unit is transferred through the circuit board to the U-shaped fixing member. An inward recessed space defined through the U-shaped fixing member is helpful for heat dissipation by radiation. Moreover, the U-shaped fixing member can also transfer heat by conduction to the frame body and the back plate. That will enhance the heat dissipation from the ceiling mount lamp to the outside. With effective heat dissipation, all electric parts of the ceiling mount lamp in accordance with the present invention, such as the LED unit and the circuit board, can prevent from damage due to heat accumulation therein. Therefore, the service life of all electric parts can be prolonged and the illumination of the LED unit is more stable.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a ceiling mount LED lamp having a fixing structure capable of assisting heat dissipation according to an embodiment of the present invention;

FIG. 2 is an exploded view of the ceiling mount LED lamp having a fixing structure capable of assisting heat dissipation according to an embodiment of the present invention;

FIG. 3 is a perspective view of a U-shaped fixing member according to an embodiment of the present invention; and

FIG. 4 is a cross-sectional view of the ceiling mount LED lamp having a fixing structure capable of assisting heat dissipation according to an embodiment of the present invention.

### DETAILED DESCRIPTION OF THE PREFERRED EMBODIMENT

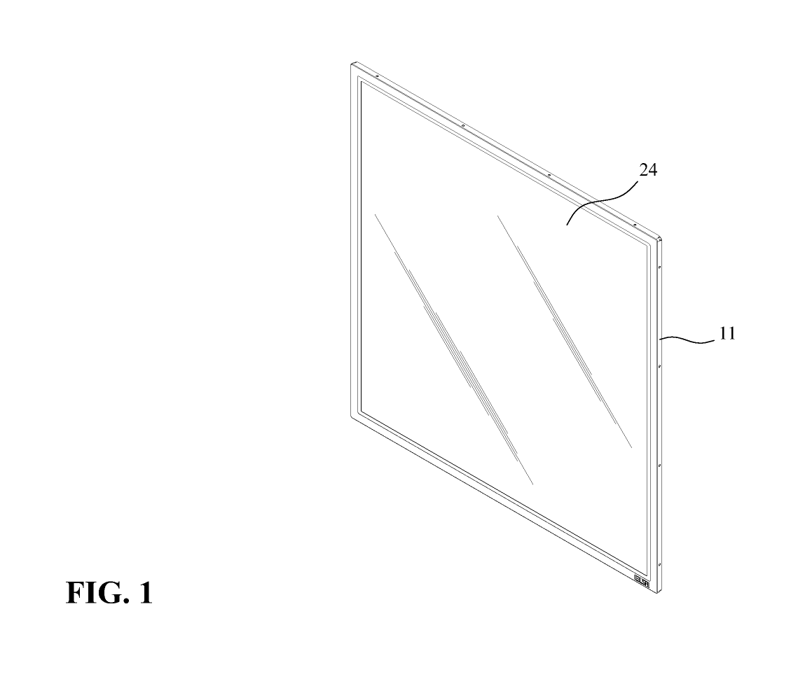

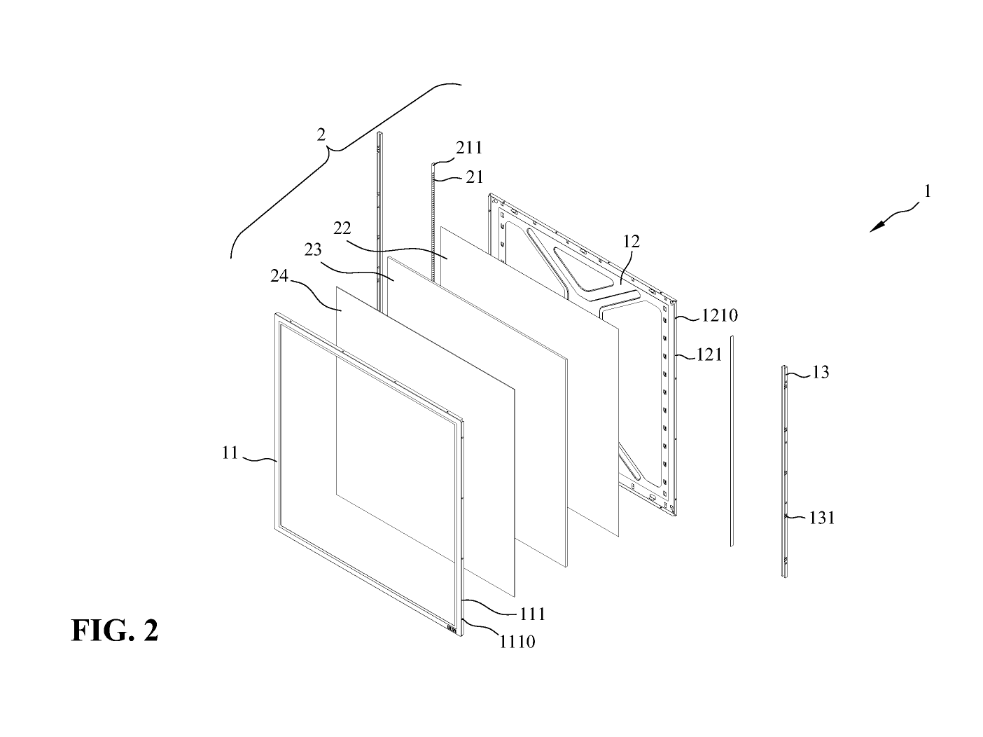

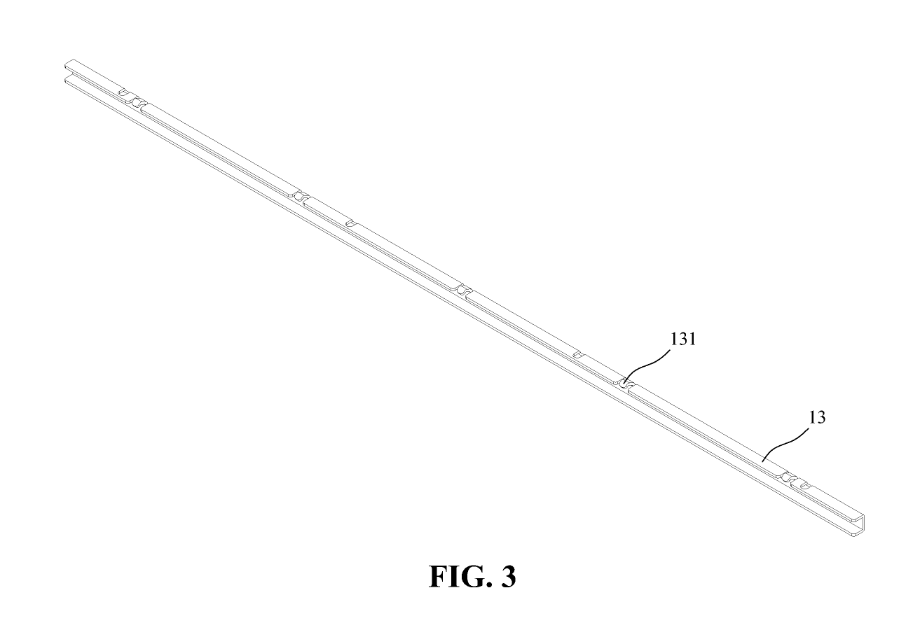

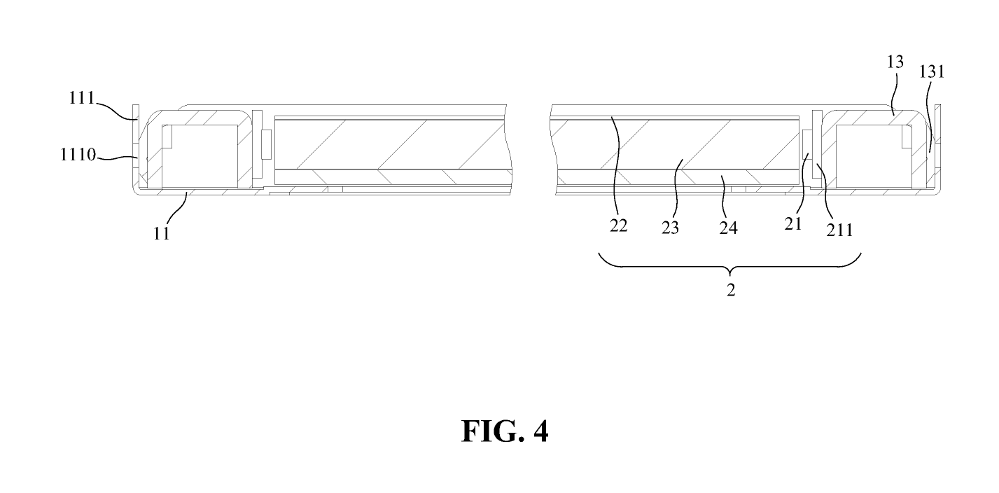

Referring to FIG. 1 to FIG. 4, a ceiling mount lamp having a fixing structure capable of assisting heat dissipation according to the present invention comprises a fixing unit 1 and a lighting unit 2.

The fixing unit 1 includes a frame body 11 having folded edges 111 equipped with at least one hook hole 1110, and a back plate 12 assembled with the frame body 11 and having buckling edges 121 equipped with at least one buckling hole 1210.

The lighting unit 2 is installed between the frame body 11 and the back plate 12 of the fixing unit 1. The lighting unit 2 includes a reflective sheet 22, a light guide plate 23, and a diffusion sheet 24. The reflective sheet 22 is installed on the back plate 12 of the fixing unit 1, and the light guide plate 23 is installed on the reflective sheet 22. At least one side of the light guide plate 23 is installed with a circuit board 211 on which an LED unit 21 is disposed. Light emitted by the LED unit 21 is reflected by the reflective sheet 22, and the light guide plate 23 is provided for guiding the light emitted by the LED unit 21 and reflected from the reflective sheet 22. The diffusion sheet 24 is installed on the light guide plate 23 and provided for further diffusing and softening the light emitted by the LED unit 21 and reflected from the reflective sheet 22 and guided through the light guide plate 23.

At least one side between the frame body 11 and the back plate 12 of the fixing unit 1 is mounted with a U-shaped fixing member 13. One outer surface of the U-shaped fixing member 13 is fastened with the circuit board 211, and another outer surface of the U-shaped fixing member 13 is provided with at least a hook part 131. The hook part 131 provides an elastic force to push against the circuit board 211 and the LED unit 21, such that the circuit board 211 and the LED unit 21 are pressed close to the light guide plate 23, thereby the light guide performance of the light guide plate 23 and the illumination can be enhanced.

The U-shaped fixing member 13 is preferably made of copper or other materials having elasticity and a good heat dissipation property, so as to facilitate heat dissipation.

According to the present invention, when the LED unit 21 is lit, the heat generated by the LED unit 21 is transferred through the circuit board 211 to the U-shaped fixing member 13. An inward recessed space defined through the U-shaped fixing member 13 is helpful for heat dissipation by radiation. Moreover, the U-shaped fixing member 13 can also transfer heat by conduction to the frame body 11 and the back plate 12. That will enhance the heat dissipation from the ceiling mount lamp to the outside. With effective heat dissipation, all electric parts of the ceiling mount lamp in accordance with the present invention, such as the LED unit 21 and the circuit board 211, can prevent from damage due to heat accumulation therein. Therefore, the service life of all electric parts can be prolonged and the illumination of the LED unit 21 is more stable.

Moreover, the hook part 131 of the U-shaped fixing member 13 is hooked with the hook hole 1110 of the frame body 11. Except that the ceiling mount lamp of the present invention has the advantage of simple and fast assembly, the hook part 131 of the U-shaped fixing member 13 provides an elastic force to push against the circuit board 211 and the LED unit 21, such that the circuit board 211 and the LED unit 21 are pressed close to the light guide plate 23, thereby the ceiling mount lamp has a better light guide performance. In addition, the hook part 131 of the U-shaped fixing member 13 allows the internal parts of the ceiling mount lamp to be assembled more compact and not easily loosening.

In accordance with the foregoing description, the ceiling mount lamp of the present invention has a fixing structure not only capable of assisting heat dissipation but also being easily assembled and disassembled.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A ceiling mount lamp having a fixing structure capable of assisting heat dissipation, comprising:
a fixing unit comprising a frame body having folded edges equipped with at least one hook hole, and a back plate assembled with the frame body and having buckling edges equipped with at least one buckling hole;
a lighting unit installed between the frame body and the back plate of the fixing unit, the lighting unit comprising a reflective sheet and a light guide plate, the reflective sheet installed on the back plate of the fixing unit, the light guide plate installed on the reflective sheet,
wherein at least one side of the light guide plate is provided with a circuit board on which an LED unit is disposed, and at least one side between the frame body and the back plate of the fixing unit is mounted with a U-shaped fixing member, one outer surface of the U-shaped fixing member is fastened with the circuit board, and another outer surface of the U-shaped fixing member is provided with at least a hook part, which provides an elastic force to push against the circuit board and the LED unit, such that the LED unit is pressed close to the light guide plate.

2. The ceiling mount lamp according to claim 1, wherein a diffusion sheet is installed on the light guide plate.
